(19) United States
(12) Patent Application Publication
(10) Pub. No.: US 2014/0372631 A1
(43) Pub. Date: Dec. 18, 2014

(54) ADAPTIVE CABLE INTERFACE

(71) Applicant: International Business Machines Corporation, Armonk, NY (US)

(72) Inventors: John E. Moore, JR., Brownsburg, IN (US); Jeffrey K. Price, Austin, TX (US); Robert R. Wentworth, Round Rock, TX (US); Stanley C. Wood, Round Rock, TX (US)

(21) Appl. No.: 13/916,260

(22) Filed: Jun. 12, 2013

(51) Int. Cl. G06F 13/42

(52) U.S. Cl. CPC G06F 13/4252
USPC 710/11

(57) ABSTRACT

A computer implemented method, a computer program product, and a computer negotiate pin assignment for a cabling interface. A cabling interface discovers an attached device through an interrogation from a connected port. The cabling interface performs a handshake with the attached device. The handshake shares information on the protocols, bandwidth needs, streams and pins supported by the attached device. The cabling interface declares a set of supported streams needed for communication by the cabling interface. The cabling interface negotiates pin layout for each streams that will be used for communication between the cabling interface and the attached device. The cabling interface assigns pins based on needs of the attached device and needs of the cabling interface.

### BACKGROUND

1. Field

The disclosure relates generally to a computer implemented method, a computer program product, and a data processing system. More specifically, the disclosure relates to a computer implemented method, a computer program product, and a data processing system having an adaptive cabling interface that supports a plurality of communication protocols.

2. Description of the Related Art

Currently, electronic devices have multiple interface cabling systems or configurations, designed around set specifications. The myriad cable types cause a problem in and of themselves because of the differing standards, and causes a condition wherein many multiple cable types are needed to attach or cluster devices together.

For example, high definition multimedia interface (HDMI) connections implements an EIA/CEA-861 standard, which defines video formats and waveforms transport of compressed, uncompressed, and LPCM audio, auxiliary data, and implementations of the VESA EDID. A plurality of HDMI input ports define video formats including pixel counts and refresh rates, HDMI ethernet channel/audio return channel, and content type.

On the other hand, a universal serial bus (USB) connection specifies a plurality of data transfer rates, and power transmissions. Over a plurality of logical channels, you can meet trends meet at Steve's of 35 Mb per second 280 Mb per second or 480 min. per second, or 625 Mb per second. Additionally, a 5 volt current is also provided on a single wire to provide power to connected devices.

Still further, an RCA cable, sometimes called a photo connector or cinch connector, is often used to connect audio or video components. For transmitting digital data, RCA cables should meet the S/PDIF specification. The S/PDA I asked Tim. Two channels of PCM audio, or a multichannel compressed surround sound format such as Dolby Digital or DTS.

All existing patch cables follow a fixed standard, and do not provide software adaptability or interlock of communication between devices. Specific signals will always be on specific pins of the connector, and this will not change. This limits the usability, expandability, and most importantly, the adaptability of the cabling interface.

As can be seen from the above examples, the myriad cable types cause a problem in and of themselves because of the differing standards. These heterogeneous cabling requirements cause a condition wherein many multiple cable types are needed to attach or cluster devices together. In the example of a home media configuration, increased complexity and expense results, as many multiple cable types are required to cable the system together.

### SUMMARY

According to one embodiment of the present invention, a method for negotiating pin assignment for a cabling interface is provided. A cabling interface discovers an attached device through an interrogation from a connected port. The cabling interface performs a handshake with the attached device. The handshake shares information on the protocols, bandwidth needs, streams and pins supported by the attached device. The cabling interface declares a set of supported streams needed for communication by the cabling interface. The cabling interface negotiates pin layout for each streams that will be used for communication between the cabling interface and the attached device. The cabling interface assigns pins based on needs of the attached device and needs of the cabling interface.

According to another embodiment of the present invention, a computer program product is provided for negotiating pin assignment for a cabling interface. A computer readable storage medium has program instructions stored thereon. The program instructions discover an attached device through an interrogation from a connected port. The program instructions perform a handshake with the attached device, wherein the handshake shares information on the protocols, bandwidth needs, streams and pins supported by the attached device. The program instructions declare a set of supported streams needed for communication by the cabling interface. The program instructions negotiate a pin layout for each stream that will be used for communication between the cabling interface and the attached device. The program instructions assign pins based on needs of the attached device and needs of the cabling interface.

According to another embodiment of the present invention, a computer is provided. The computer comprises a computer readable storage medium having computer readable instructions encoded thereon for negotiating pin assignment for a cabling interface. A bus connects the computer readable storage medium to a processor that executes the computer readable instructions. The computer readable instructions are executed to discover an attached device through an interrogation from a connected port. The computer readable instructions are executed to perform a handshake with the attached device. The handshake shares information on the protocols, bandwidth needs, streams and pins supported by the attached device. The computer readable instructions are executed to declare a set of supported streams needed for communication by the cabling interface. The computer readable instructions are executed to negotiate for each stream that will be used for communication between the cabling interface and the attached device. The computer readable instructions are executed to assign pins based on needs of the attached device and needs of the cabling interface.

### BRIEF DESCRIPTION OF THE SEVERAL VIEWS OF THE DRAWINGS

FIG. 1 is an illustrative diagram of a data processing environment in which illustrative embodiments may be implemented;

FIG. 2 is an illustration of a data processing system in accordance with an illustrative embodiment;

FIG. 3 is a data flow for negotiating connection parameters between adaptive ports of electronic devices is shown according to an illustrative embodiment;

FIG. 4 is an adaptive cable shown according to an illustrative embodiment;

FIG. 5 is an adaptive cable shown according to an illustrative embodiment;

FIG. 6 is a flowchart of a process for negotiating pin assignment in an adaptive cabling system according to an illustrative embodiment; and

FIG. 7 is a flowchart of a process for cable pin out assignment handshake and negotiation according to an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

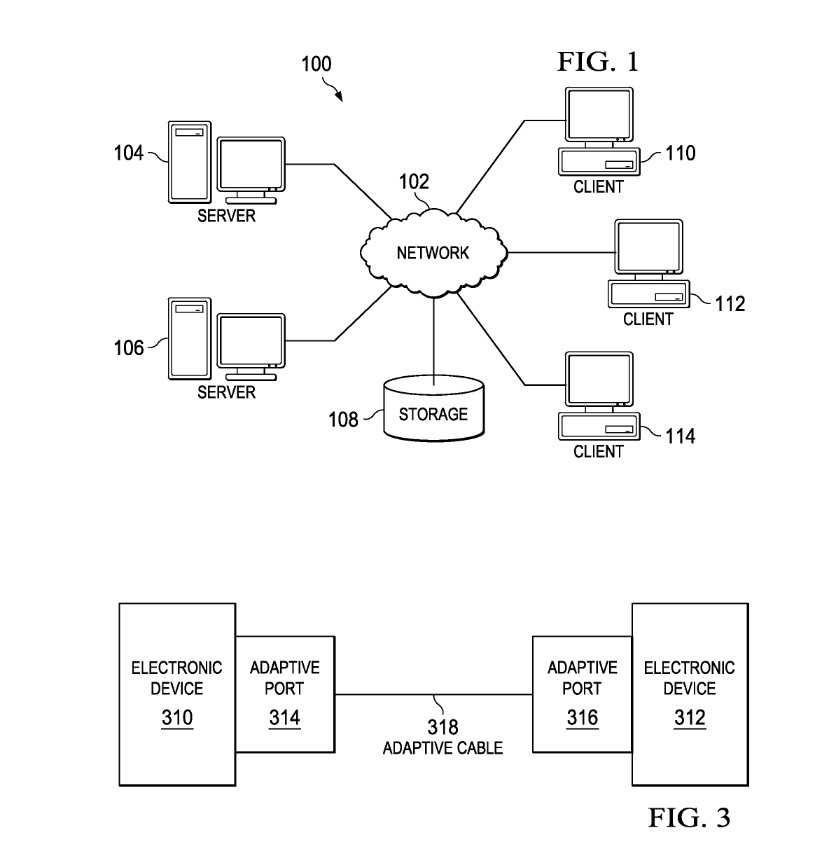

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

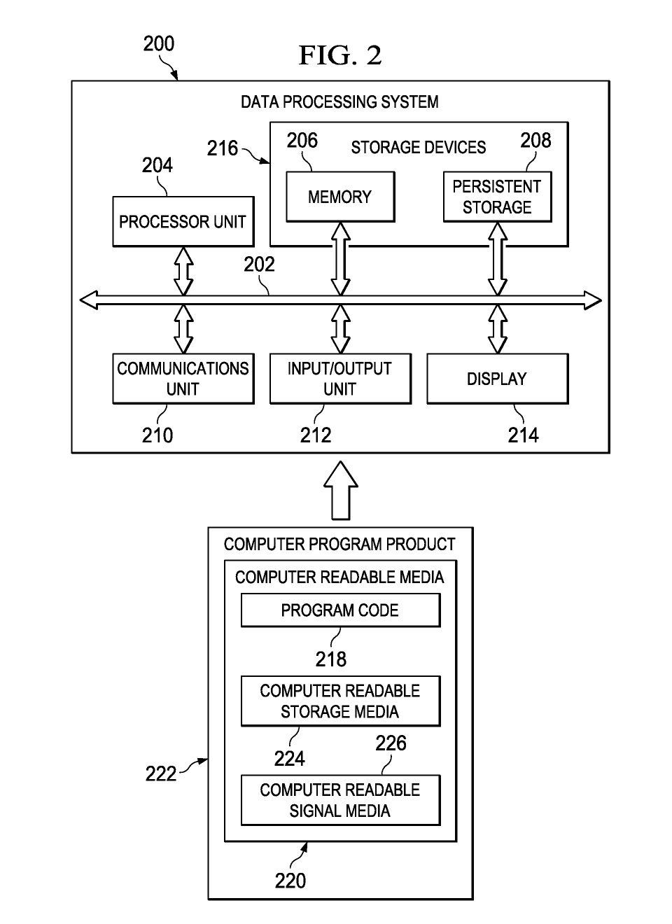

Turning now to FIG. 2, an illustration of a data processing system is depicted in accordance with an illustrative embodiment. Data processing system 200 may be a server computer such as server computer 104 and server computer 106 of FIG. 1. Data processing system 200 may also be a client computer, such as client computers 110, 112, and 114 of FIG. 1. In this illustrative example, data processing system 200 includes communications framework 202, which provides communications between processor unit 204, memory 206, persistent storage 208, communications unit 210, input/output (I/O) unit 212, and display 214. In these examples, communications frame work 204 may be a bus system.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these examples, computer readable storage media 224 is a physical or tangible storage device used to store program code 218 rather than a medium that propagates or transmits program code 218. Computer readable storage media 224 is also referred to as a computer readable tangible storage device or a computer readable physical storage device. In other words, computer readable storage media 224 is a media that can be touched by a person.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 206, or a cache, such as found in an interface and memory controller hub that may be present in communications framework 202.

All existing patch cables follow a fixed standard, and do not provide software adaptability or interlock of communication between devices. Specific signals will always be on specific pins of the connector, and this will not change. This limits the usability, expandability, and most importantly, the adaptability of the cabling interface.

Illustrative embodiments described herein provide a device that can be incorporated into home media, PC, or enterprise systems that allows for automatic configuration of all exported interfaces (ethernet, scsi, usb, etc.) from a device to a client or control device (i.e. a game station connecting to a HD TV set), and discovering and configuring the interfaces for HDMI, ethernet, digital sound, usb, etc. A patch cord system that uses a standard interface design, and a protocol based handshake between devices, to configure the connection for optimum performance and obviate the need for multiple types of cable/patch cords. This type of cable interface has the ability to carry both analog and digital data (such as sound, video, etc.) by assigning pins to different i/o types based on the handshakes between interfaces. Our invention would allow for much greater flexibility and protection against obsolescence.

The interface itself becomes adaptive, thru the use of a handshake protocol for assigning data types and paths in the cable. The invention allows for a single cable design to be used with multiple differing types of interfaces, allowing users to upgrade devices without the added expense of replacing cables. The handshake between the devices for assignment of data feeds is handled in software. This will allow devices to be upgraded with software updates to support new standards as they become available, thus guarding against obsolescence.

Referring now to FIG. 3, a data flow for negotiating connection parameters between adaptive ports of electronic devices is shown according to an illustrative embodiment. Electronic device 310 and electronic device 312 can be, for example but not limited to, computers at a, of FIG. 1.

Electronic device 310 includes adaptive port 314. Electronic device 312 includes adaptive port 316. Adaptive port 314 and adaptive port 316 are interfaces that allow for discovering and configuring the Adaptive port 314 and adaptive port 316 for data trial court to allow you will protocols, including but not limited to HDMI, ethernet, digital sound, usb, etc. a protocol based handshake between devices, to configure the connection for optimum performance and obviate the need for multiple types of cable/patch cords. This type of cable interface has the ability to carry both analog and digital data (such as sound, video, etc.) by assigning pins to different i/o types based on the handshakes between interfaces. Our invention would allow for much greater flexibility and protection against obsolescence.

Adaptive port 314 is connected to adaptive port 316 via adaptive cable 318. Cable specifications for adaptive cable 318 include a minimum of a 24 pin cable. Cable specifications for adaptive cable 318 is able to support, at a minimum, current cabling specifications for digital audio and video, analog audio and video, up to cat 6 ethernet cable, up to usb 3.0, etc. However, Cable specifications for adaptive cable 318 need not necessarily support each of these current cabling specifications at the same time. The protocol will negotiate for mandatory signal types to support, along with highest available supported signal type.

At any point the adaptive interface on either the client or server can request re-assignment of pins to support other functions that have been moved up the priority queue. This is to allow devices to support additional, alternative functions that may now be advantageous or required, such as a client request to switch from digital audio to analog audio for content support.

Referring now to FIG. 4, an adaptive cable is shown according to an illustrative embodiment. Adaptive cable 400 is adaptive cable 318 of FIG. 3.

Adaptive cable 400 includes a plurality of pins 410. Each of the plurality of pins 400 and is an electrical connection used to transmit information, or transmit power through a discrete channel or wire of adaptive cable 400.

According to an illustrative embodiment, Cable specifications should include a minimum of a 24 pin cable, and must be able to support, at a minimum, all current cabling specifications for digital audio and video, analog audio and video, up to cat 6 ethernet cable, up to usb 3.0. However, cable specifications need NOT necessarily support all specifications at the same time. The protocol will negotiate for mandatory signal types to support, along with highest available supported signal type.

In one illustrative embodiment, plurality of pins 410 includes first pin 412 and second pin 414. first pin 412 and second pin 414 are kept permanently assigned for the device negotiation protocol thru serial or other simple protocol for used the device negotiation protocol thru serial or other simple protocol.

In one illustrative embodiment, plurality of pins 410 includes third pin 416. Third pin 416 is initially configured as a presence indicator. Presence indicator line is then disconnected, and set to an unassigned state for reuse.

The remainder of the plurality of pins 510 can be negotiated and assigned to various to transmit information, or transmit power through a discrete channel or wire of adaptive cable 500.

Others of the plurality of pins 410 can be reconfigured according to a negotiated protocol.

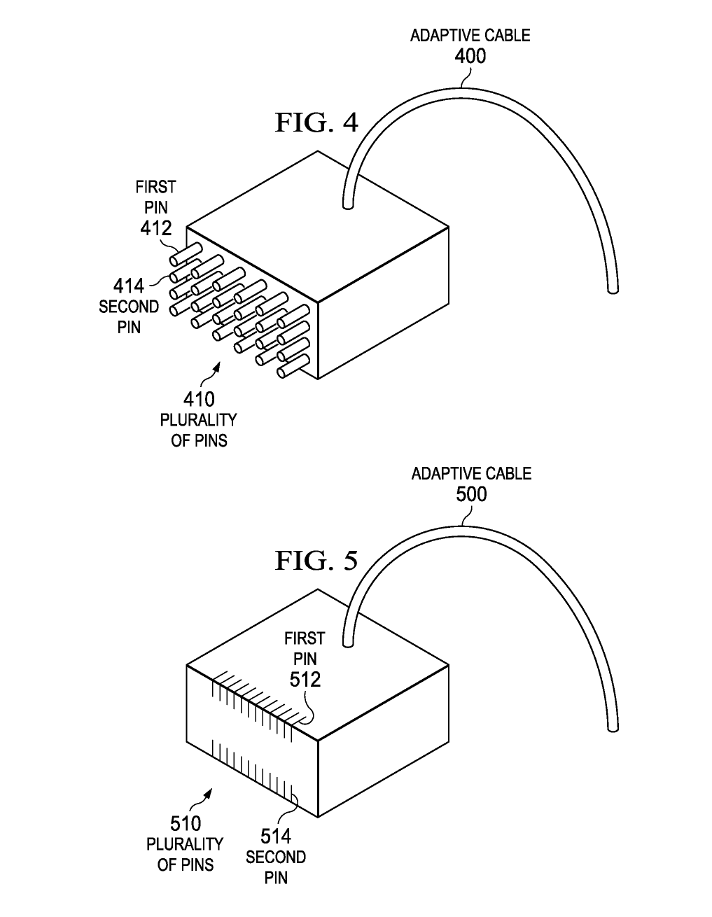

Referring now to FIG. 5, an adaptive cable is shown according to an illustrative embodiment. Adaptive cable 500 is adaptive cable 318 of FIG. 3.

Adaptive cable 500 includes a plurality of pins 510. Each of the plurality of pins 500 and is an electrical connection used to transmit information, or transmit power through a discrete channel or wire of adaptive cable 500.

In one illustrative embodiment, plurality of pins 510 includes first pin 512 and second pin 514. first pin 512 and second pin 514 are kept permanently assigned for the device negotiation protocol thru serial or other simple protocol for used the device negotiation protocol thru serial or other simple protocol.

In one illustrative embodiment, plurality of pins 510 includes third pin 516. Third pin 516 is initially configured as a presence indicator. Presence indicator line is then disconnected, and set to a non-assigned state for reuse.

The remainder of the plurality of pins 510 can be negotiated and assigned to various to transmit information, or transmit power through a discrete channel or wire of adaptive cable 500.

Others of the plurality of pins 510 can be configured and reconfigured according to a negotiated protocol.

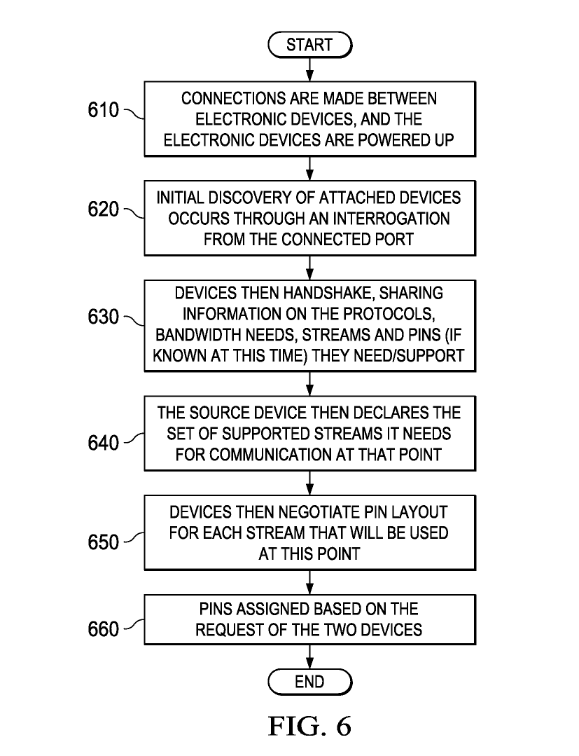

Referring now to FIG. 6, a flowchart shown for negotiating pin assignment in an adaptive cabling system according to an illustrative embodiment. Process 600 is a software process executing within an adaptive port, such as adaptive port 314 or adaptive port 318 of FIG. 3.

Process 600 begins when Connections are made between electronic devices, and the electronic devices are powered up (step 610).

Initial discovery of attached devices occurs through an interrogation from the connected port (step 620). The presence pulse can be, for example a low voltage pulse transmitted through a designated pin of the adaptive cabling system. In one illustrative embodiment, the designated pin can be third pin 416 of FIG. 4. Presence indicator (pin 3) goes “live” on connection of devices. The connection can be for example a male cable end from a master electronic device connected to a female cable end on a client electronic device).

The devices then handshake, sharing information on the protocols, bandwidth needs, streams and pins (if known at this time) they need/support (step 630).

Based on the data needs, the source device then declares the set of supported streams it needs for communication at that point (step 640). This can be renegotiated at any point between the devices to change data types and formats.

The devices then negotiate pin layout for each streams that will be used at this point (step 650).

Pins assigned based on the request of the two devices (step 660), with the process terminating thereafter.

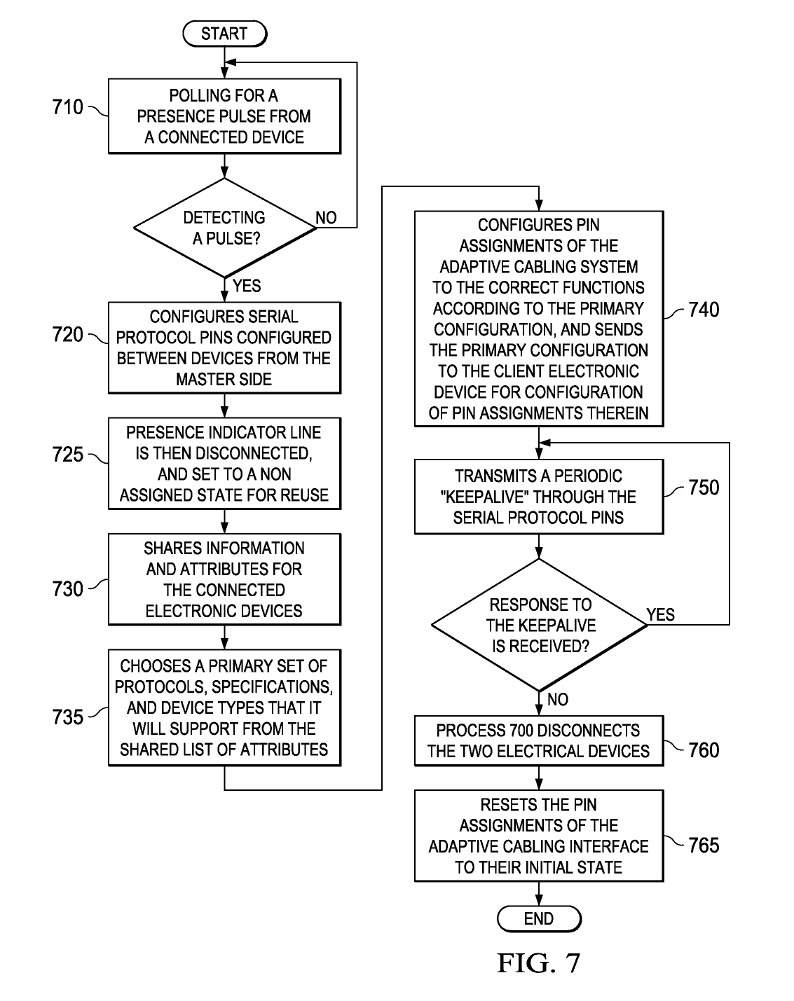

Referring now to FIG. 7 a flowchart shown for cable pin out assignment handshake and negotiation. Process 700 is a software process for performing a handshake and negotiation of pin assignment and protocol selections. Process 700 can be a process such as described in steps 630-650 of FIG. 6.

Process 700 begins by polling for a presence pulse from a connected device (step 710). The presence pulse can be, for example a low voltage pulse transmitted through a designated pin of the adaptive cabling system. In one illustrative embodiment, the designated pin can be third pin 416 of FIG. 4. Presence indicator (pin 3) goes “live” on connection of devices. The connection can be for example a male cable end from a master electronic device connected to a female cable end on a client electronic device).

Responsive to not detecting a pulse (“no” at step 715), process 700 iterates back to step 710 And continues to poll. Responsive to detecting a pulse (“yes” at step 715), process 700 configures serial protocol pins configured between devices from the master side (step 720). In one illustrative embodiment, the serial protocol pins can be configured using a network protocol such as dynamic host configuration protocol (DHCP). In one illustrative embodiment, the serial protocol pin can be first pin 412, and second pin 414 of FIG. 4. In one illustrative like, electronic devices are preconfigured with serial configuration for transmission settings such as but not limited to, line speed, and acceptable packet sizes.

Presence indicator line is then disconnected, and set to a non-assigned state for reuse (step 725).

Process 700 shares information and attributes for the connected electronic devices (step 730). The share information and attributes can include, but are not limited to, supported protocols, specifications, device types, and priority ordering of connections.

Process 700 chooses a primary set of protocols, specifications, and device types that it will support from the shared list of attributes (step 735). The primary set of protocols, specifications, and device types are selected from the shared information and attributes of step 730 described above.

Process 700 configures pin assignments of the adaptive cabling system to the correct functions according to the primary configuration, and sends the primary configuration to the client electronic device for configuration of pin assignments therein (step 740). Once configured, process 700 transmits information or power through the discrete channels of the adaptive cable (step 745).

Process 700 transmits a periodic “keepalive” through the serial protocol pins (step 750). The “keepalive” validate connection status between the connected electronic devices. The keepalive is a message sent the connected electronic devices to check that the link between the two is operating, or to prevent this link from being broken. The only purpose of the keepalive is to verify connection status. Therefore, the keepalive messages tend to be short and not take much bandwidth. The precise format and usage depend on the communication protocol utilized between the connected electronic devices.

If a response to the keep alive is received (“yes” at step 755), process 700 iterates back to step 750.

If a response to the keep alive is not received (“no” at step 755), process 700 disconnects the two electrical devices (step 760). Process 710 resets the pin assignments of the adaptive cabling interface to their initial state (step 765), with the process terminating thereafter.

### EXAMPLES

Table 8 is a first example of a negotiated pin configuration is shown according to an illustrative embodiment. Table 8 is a negotiated pin configuration for devices supporting USB 3.0, 1000Base-T ethernet, and analog Audio.

TABLE 8

| | | supported signal or |
|---|---|---|
| Pin number | wire description | specification |
| 1 | Data− | Serial protocol |
| 2 | Data+ | Serial protocol |
| 3 | +5 VDC | USB 3.0 |
| 4 | Data− | USB 3.0 |
| 5 | Data+ | USB 3.0 |
| 6 | Ground | USB 3.0 |
| 7 | USB 3.0 Data Receive | USB 3.0 |
| | (differential) | |
| 8 | USB 3.0 Data Receive | USB 3.0 |
| | (differential) | |
| 9 | Ground | USB 3.0 |
| 10 | USB 3.0 Data Transmit | USB 3.0 |
| | (differential) | |
| 11 | USB 3.0 Data Transmit | USB 3.0 |
| | (differential) | |
| 12 | Transmit Data+ | 1000Base-T |
| 13 | Transmit Data− | 1000Base-T |
| 14 | Receive Data+ | 1000Base-T |
| 15 | Bi-directional+ | 1000Base-T |
| 16 | Bi-directional− | 1000Base-T |
| 17 | Receive Data− | 1000Base-T |
| 18 | Bi-directional+ | 1000Base-T |
| 19 | Bi-directional− | 1000Base-T |
| 20 | Right+ | Left/Right analog |
| | | audio channel |
| 21 | Right Ground | Left/Right analog |
| | | audio channel |
| 22 | Left+ | Left/Right analog |
| | | audio channel |
| 23 | Left Ground | Left/Right analog |
| | | audio channel |
| 24 | No Connection | |

Table 9 is a second example of a negotiated pin configuration is shown according to an illustrative embodiment. Table 9 is a negotiated pin configuration for devices supporting HDMI 1.4 standard plus USB 2.0.

TABLE 9

| | | supported signal or |
|---|---|---|
| Pin number | wire description | specification |
| 1 | Data− | Serial protocol |
| 2 | 2 Data+ | Serial protocol |
| 3 | TMDS channel 2+ | HDMI 1.4 specification |
| 4 | TMDS channel 2 shield | HDMI 1.4 specification |
| 5 | TMDS channel 2− | HDMI 1.4 specification |
| 6 | TMDS channel 1+ | HDMI 1.4 specification |
| 7 | TMDS channel 1 shield | HDMI 1.4 specification |
| 8 | TMDS channel 1− | HDMI 1.4 specification |
| 9 | TMDS channel 0+ | HDMI 1.4 specification |
| 10 | TMDS channel 0 shield | HDMI 1.4 specification |
| 11 | TMDS channel 0− | HDMI 1.4 specification |
| 12 | TDMS clock+ | HDMI 1.4 specification |
| 13 | TDMS clock shield | HDMI 1.4 specification |
| 14 | TDMS clock− | HDMI 1.4 specification |
| 15 | CEC | HDMI 1.4 specification |
| 16 | Utility/HEAC+ | HDMI 1.4 specification |
| 17 | DDC I²C clock SCL | HDMI 1.4 specification |
| 18 | DDC I²C data SDA ″ | HDMI 1.4 specification |
| 19 | DDC/CEC/HEC shield | HDMI 1.4 specification |
| 20 | +5 VDC power | (HDMI and USB +5 V |
| | | support) |
| 21 | Hot Plug Detect HEC data+ | |
| 22 | Data− | USB 2.0 |
| 23 | Data+ | USB 2.0 |
| 24 | Ground | USB 2.0 |

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for negotiating pin assignment for a cabling interface, the method comprising:
discovering, by the cabling interface, an attached device through an interrogation from a connected port by detecting a low voltage presence pulse transmitted through a designated pin of the cabling interface;
responsive to discovering the attached device, setting the designated pin to a unassigned state for reuse in a subsequent communication between the cabling interface and the attached device;
performing, by the cabling interface, a handshake with the attached device, wherein the handshake shares information on the protocols, bandwidth needs, streams and pins supported by the attached device;
declaring, by the cabling interface, a set of supported streams needed for communication by the cabling interface;
negotiate pin layout, by the cabling interface, for each streams that will be used for communication between the cabling interface and the attached device; and
assigning, by the cabling interface, pins based on needs of the attached device and needs of the cabling interface.

2-3. (canceled)

4. The method of claim 1, further comprising:
responsive to perform the handshake with the attached device, configuring a pair of serial protocol pins using a network configuration protocol.

5. The method of claim 4, wherein each of the cabling interface and attached device is preconfigured with a serial configuration for transmission settings comprising line speed, and acceptable packet sizes.

6. The method of claim 1, wherein the handshake further handshake shares information on the protocols, bandwidth needs, streams and pins supported by the attached device supported protocols, specifications, device types, and priority ordering of connections.

7. The method of claim 4 further comprising:
transmitting a periodic message through the pair serial protocol pins to verify a connection status check of the attached device; and
responsive to not receiving a response to the periodic message, resetting the pin assignments of the cabling interface to an initial state.

8. A computer program product for negotiating pin assignment for a cabling interface, comprising:
a non-transitory computer readable storage medium;
program instructions, stored on the computer readable storage medium, to discover an attached device through an interrogation from a connected port by detecting a low voltage presence pulse transmitted through a designated pin of the cabling interface;
program instructions, stored on the computer readable storage medium, responsive to discovering the attached device, to set the designated pin to a unassigned state for reuse in a subsequent communication between the cabling interface and the attached device;
program instructions, stored on the computer readable storage medium, to perform a handshake with the attached device, wherein the handshake shares information on the protocols, bandwidth needs, streams and pins supported by the attached device;
program instructions, stored on the computer readable storage medium, to declare a set of supported streams needed for communication by the cabling interface;
program instructions, stored on the computer readable storage medium to negotiate a pin layout for each streams that will be used for communication between the cabling interface and the attached device; and
program instructions, stored on the computer readable storage medium, to assign pins based on needs of the attached device and needs of the cabling interface.

9-10. (canceled)

11. The computer program product of claim 8, further comprising:
program instructions, stored on the computer readable storage medium, responsive to perform the handshake with the attached device, to configure a pair of serial protocol pins using a network configuration protocol.

12. The computer program product of claim 11, wherein each of the cabling interface and attached device is preconfigured with a serial configuration for transmission settings comprising line speed, and acceptable packet sizes.

13. The computer program product of 8, wherein the handshake further handshake shares information on the protocols, bandwidth needs, streams and pins supported by the attached device supported protocols, specifications, device types, and priority ordering of connections.

14. The computer program product of claim 11 further comprising:
program instructions, stored on the computer readable storage medium, to transmit a periodic message through the pair serial protocol pins to verify a connection status check of the attached device; and
program instructions, stored on the computer readable storage medium, responsive to not receiving a response to the periodic message, to reset the pin assignments of the cabling interface to an initial state.

15. A computer comprising:
a computer readable storage medium having computer readable instructions encoded thereon for negotiating pin assignment for a cabling interface;
a bus connecting the computer readable storage medium to a processor; and
a processor, wherein the processor executes the computer readable instructions:
to discover an attached device through an interrogation from a connected port by detecting a low voltage presence pulse transmitted through a designated pin of the cabling interface;
responsive to discovering the attached device, to set the designated pin to a unassigned state for reuse in a subsequent communication between the cabling interface and the attached device;
to perform a handshake with the attached device, wherein the handshake shares information on the protocols, bandwidth needs, streams and pins supported by the attached device;
to declare a set of supported streams needed for communication by the cabling interface;
to negotiate for each streams that will be used for communication between the cabling interface and the attached device; and
to assign pins based on needs of the attached device and needs of the cabling interface.

16-17. (canceled)

18. The computer of claim 15, wherein the processor further executes the computer readable instructions:
responsive to perform the handshake with the attached device, to configure a pair of serial protocol pins using a network configuration protocol.

19. The computer of claim 18, wherein each of the cabling interface and attached device is preconfigured with a serial configuration for transmission settings comprising line speed, and acceptable packet sizes.

20. The computer of claim 15, wherein the handshake further handshake shares information on the protocols, bandwidth needs, streams and pins supported by the attached device supported protocols, specifications, device types, and priority ordering of connections.

21. The computer of claim 18, wherein the processor further executes the computer readable instructions:
to transmit a periodic message through the pair serial protocol pins to verify a connection status check of the attached device; and
responsive to not receiving a response to the periodic message, to reset the pin assignments of the cabling interface to an initial state.
